(19) United States
(12) Patent Application Publication
(10) Pub. No.: US 2026/0140387 A1
(43) Pub. Date: May 21, 2026

(54) TIME MULTIPLEXING DISPLAY WITH ANGULAR PIXEL SHIFTING

(71) Applicant: GOOGLE LLC, Mountain View, CA (US)

(72) Inventors: Oleg Yaroshchuk, Mountain View, CA (US); Nam-Hyong Kim, San Jose, CA (US); Michael Anthony Klug, Austin, TX (US)

(21) Appl. No.: 18/949,556

(22) Filed: Nov. 15, 2024

(51) Int. Cl. G02B 27/01

(52) U.S. Cl. CPC G02B 27/0179; G02B 27/0172; G02B 2027/0178

(57) ABSTRACT

An apparatus includes a pixel shifter to receive light representative of pixels and to modify a first angle of the light to one of a plurality of predetermined second angles based on a control signal. The apparatus also includes a controller to provide the control signal to the pixel shifter. The control signal indicates different ones of the plurality of predetermined second angles in different time intervals corresponding to subframes of an image frame produced by the plurality of pixels. In some cases, the apparatus also includes a waveguide to receive the light from the pixel shifter and to convey the light to a diffractive optical structure that renders the light visible to a user. The pixel shifter can modify the first angle to increase a resolution of some or all the image perceived by the user or to mitigate or eliminate local defects in the display.

### BACKGROUND

Virtual reality (VR), augmented reality (AR), and mixed reality (MR) systems allow users to experience an immersive virtual world that can include or be merged with elements from the real world in the case of AR/MR. The visual experience is very important in VR, AR, and MR, and these systems typically include a near-eye display or head mounted device (HMD) that is worn by the user and displays images of the virtual world. The HMD can include a support structure, a display (or image source) that generates light representing an image, and additional optical elements that convey light from the image source to the user. In AR/MR systems, light from the image source is merged with light received from the outside world to create the mixed or augmented view perceived by the user. The additional optical elements can include a light guide substrate, generally referred to as a waveguide, an input optical coupling such as an in-coupling grating (referred to herein as an “incoupler”), and an output optical coupling such as an out-coupling grating (referred to herein as an “outcoupler”). The incoupler receives light from the display and couples this light into the waveguide. The incoupled light is “guided” through the waveguide, typically by multiple instances of total internal reflection, and then exits the waveguide via the outcoupler. The light that exits the waveguide generates an image that can be viewed by the user of the HMD.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates an AR eyewear display system capable of angular pixel shifting of light representing a plurality of pixels, according to some embodiments.

FIG. 2 depicts a cross-section view of an implementation of a lens element that includes a waveguide, according to some embodiments.

FIG. 3 illustrates an optical system that supports time-multiplexing of virtual pixels that are produced by pixel shifting an image of a source pixel, according to some embodiments.

FIG. 4 illustrates an optical system that includes an electro-optical pixel shifter for performing angular pixel shifting of a source pixel to produce one or more virtual pixels, according to some embodiments.

FIG. 5 illustrates a portion of an electro-optic pixel shifter in a first state and a second state, according to some embodiments.

FIG. 6 illustrates a polarization stack that includes two incouplers that are sensitive to two orthogonal polarizations of the same type, according to some embodiments.

FIG. 7 illustrates an optical system including an electro-optical pixel shifter in a first and second states that represent switching based on a polarization state of incoming light, according to some embodiments.

FIG. 8 illustrates an optical system that includes an electro-optical pixel shifter having an active angular beam shifter and a static incoupler, according to some embodiments.

FIG. 9 illustrates pixel shifting of polarized light in one direction by an active switchable pixel shifter in a first state and a second state, according to some embodiments.

FIG. 10 illustrates pixel shifting of polarized light in one direction by a passive switchable pixel shifter in a first state and a second state, according to some embodiments.

FIG. 11 illustrates an optical system that includes an electro-mechanical pixel shifter for performing angular pixel shifting of a source pixel to produce one or more virtual pixels, according to some embodiments.

FIG. 12 illustrates angular pixel shifting by an electromechanical pixel shifter in a first state and a second state, according to some embodiments.

FIG. 13 is a set of diagrams illustrating unidirectional and bidirectional pixel shifting produced by angular pixel shifting, according to some embodiments.

FIG. 14 illustrates a VR display system that includes a pixel shifter, according to some embodiments.

### DETAILED DESCRIPTION

The primary goal of a VR, AR, or MR system is to instill a user with a sense of immersion or presence in a world that is at least partially virtual. The sense of immersion or presence can easily be broken if the user becomes aware of the pixels that represent the images in the virtual world, e.g., due to pixelation, the screen door effect, clouding of the image caused by unevenness, irregularity, or blemishes on display panels (referred to herein as “the mura effect”), or inoperative (dead) pixels that appear as bright or dark spots on the screen. The user wearing an HMD can be very sensitive to these effects, at least in part because the optical magnification is large enough to re-image individual pixels. These problems are exacerbated by the competing demands to provide a large field of view, high resolution, and high pixel density using a limited number of pixels. Similar problems can occur in other digital projection systems.

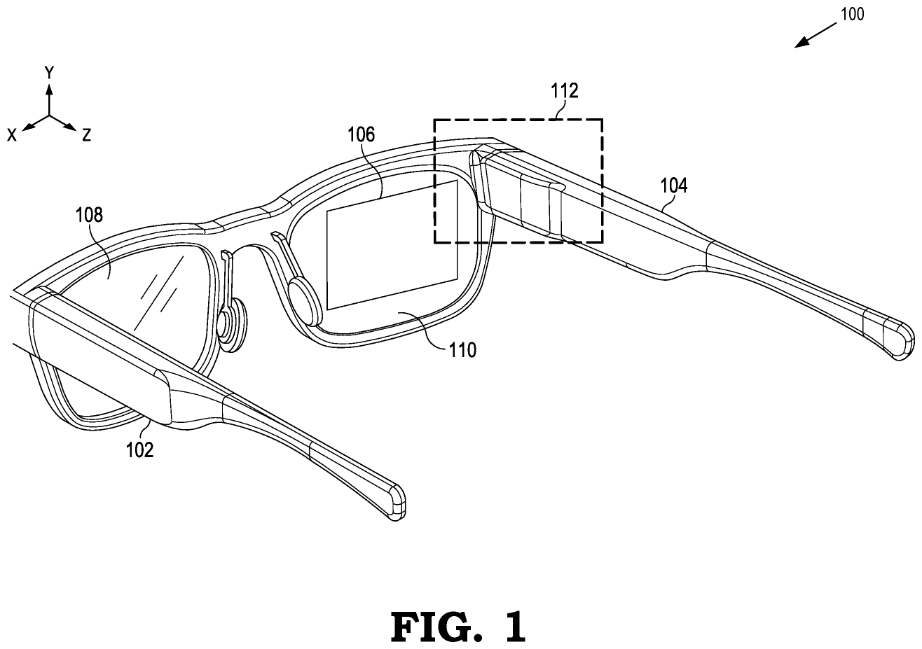

FIGS. 1-14 illustrate a pixel shifter configured to modify angles of light rays propagating between a display panel and an incoupler to a waveguide of an HMD used to implement VR, AR, or MR, which improves the resolution of a display in the HMD and reduces or eliminates immersion-breaking effects. The pixel shifter modifies the angles of the light rays in successive, different time intervals in response to control signals provided to the pixel shifter. In some embodiments, the pixel shifter modifies the angles of the light rays to one of a plurality of output angles in time intervals corresponding to subframes of a frame of an image presented to a user of the HMD. For example, the pixel shifter can diffract, refract, or reflect an incoming light ray in a first dimension to a first output angle in a first subframe of the image and a second output angle in a second subframe of the image. The angle modifications produce pixel shifting in the first dimension in the image plane. For another example, the pixel shifter can modify the angle of the incoming light rays in two dimensions in the plane of the image. A difference between the output angles of the light rays corresponds to a pixel shifting distance in the image plane. In some embodiments, the pixel shifting distance is equal to

$$n ( \frac{p}{2} ) ,$$

where n is an integer and p is the pixel pitch of the display panel. The pixel pitch can also be considered for the image produced by the optical system. The image is typically magnified relative to the size of the display, which causes a corresponding magnification of the pixel pitch of the image.
a pixel shifter can include multiple pixel shifting elements. In some embodiments, the pixel shifter includes a plurality of pixel shifting elements that are configured to modify the angles of the light rays along different directions or to modify the angles of light rays having different polarizations. Subsets of the pixels can also be shifted. In some embodiments, one or more subsets of the pixels produced by the display are shifted to increase resolution in some part of the image, e.g., for foveated imaging, or to mitigate local defects in the display panel. Examples of pixel shifters include electro-optical angular shifters (such as switchable liquid crystal compound prisms or prism arrays, liquid crystal compound surface relief gratings, liquid crystal phased arrays, liquid crystal gratings, liquid crystal polarization gratings) and electromechanical angular shifters such as tunable mirrors, micro-electromechanical systems (MEMS), and digital micromirror devices (DMD).

FIG. 1 illustrates an AR eyewear display system 100 capable of angular pixel shifting of light representing a plurality of pixels, according to some embodiments. The AR eyewear display system 100 includes a support structure 102 (e.g., a support frame) that allows a user to wear the AR eyewear display system 100 on their head. The support structure 102 includes an arm 104 that houses an optical system made up of an emissive micro-display (e.g., μLED or μOLED display) and projection optics (lenses, mirrors, pixel shifting optics) configured to project display light representative of images toward the eye of a user along a preconfigured optical path. The user perceives the projected display light as a sequence of images displayed in a field of view (FOV) area 106 at one or both of lens elements 108, 110 supported by the support structure 102. In some embodiments, the support structure 102 further includes various sensors (not shown in FIG. 1 in the interest of clarity), such as one or more front-facing cameras, rear-facing cameras, other light sensors, motion sensors, accelerometers, and the like. The support structure 102 can also include one or more radio frequency (RF) interfaces or other wireless interfaces (not shown in FIG. 1 in the interest of clarity), such as a Bluetooth™ interface, a Wi-Fi interface, and the like.

Some embodiments of the support structure 102 include one or more batteries or other portable power sources for supplying power to the electrical components of the AR eyewear display system 100. Some or all these components of the AR eyewear display system 100 are fully or partially contained within an inner volume of support structure 102, such as within the arm 104 in region 112 of the support structure 102. The illustrated embodiment of the AR eyewear display system 100 utilizes a form factor associated with spectacles or eyeglasses. However, the AR eyewear display system 100 is not limited to this form factor and can have a different shape and appearance from the eyeglasses frame depicted in FIG. 1.

One or both the lens elements 108, 110 are used by the AR eyewear display system 100 to provide an AR display that renders graphical content that is superimposed over (or otherwise provided in conjunction with) a real-world view as perceived by the user through the lens elements 108, 110. For example, micro-display light or other display light can be used to form a perceptible image or series of images that are projected onto the eye of the user via one or more optical elements, including a waveguide, formed at least partially in the corresponding lens element. In that case, one or both the lens elements 108, 110 include at least a portion of a waveguide that routes display light received by an incoupler (IC) (not shown in FIG. 1 in the interest of clarity) of the waveguide to an outcoupler (OC) (not shown in FIG. 1 in the interest of clarity) of the waveguide, which outputs the display light toward an eye of a user of the AR eyewear display system 100. Additionally, the waveguide can employ an exit pupil expander (EPE) in the light path between the IC and OC, or in combination with the OC, to increase the dimensions of the display exit pupil. Moreover, each of the lens elements 108, 110 is sufficiently transparent to allow a user to see through the lens elements to provide a field of view of the user's real-world environment such that the image appears superimposed over at least a portion of the real-world environment.

The projection system also includes a display or light engine that generates light representative of pixels that form an image. The display provides the light in time-division multiplexed intervals that are synchronized with one or more pixel shifters that modify a first, incoming angle of the light to one of a plurality of outgoing angles in successive time intervals. For example, the light generated by pixels in the display can be modified in subframes of a frame of an image. The pixel shifter modifies the incoming angle of the light to a selected one of a set of outgoing angles that correspond to different pixel shifting distances. Thus, the coordinated operation of the display and the pixel shifter produces a plurality of virtual pixels from each pixel during the different subframes. The perceived display resolution is therefore increased, and immersion-breaking effects are reduced or eliminated, within a frame that is represented by the virtual pixels in the subframes.

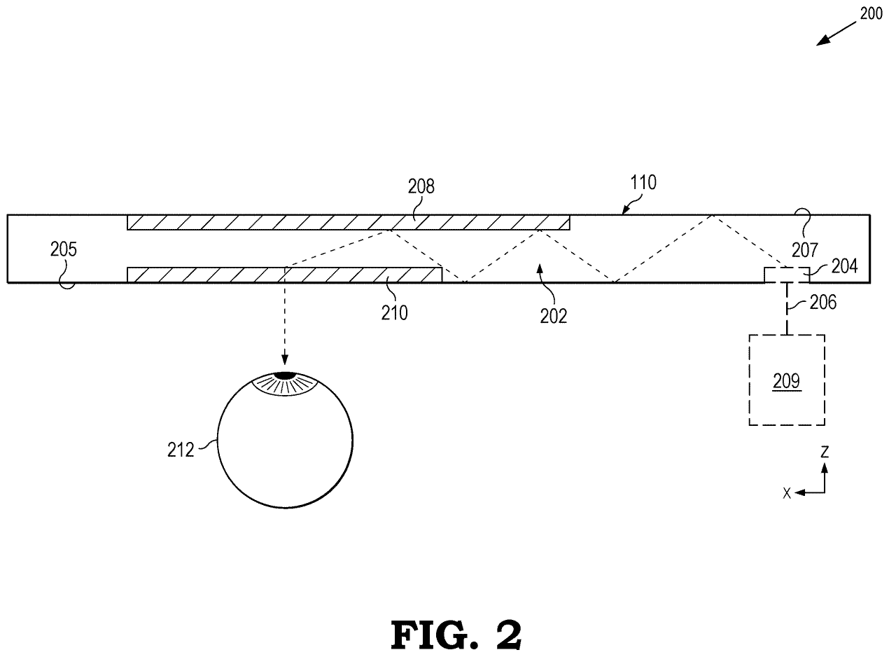

FIG. 2 depicts a cross-section view 200 of an implementation of a lens element that includes a waveguide 202, according to some embodiments. The lens element shown in FIG. 2 can be used to implement some embodiments of the lens element 110 of an AR eyewear display system such as the AR eyewear display system 100 shown in FIG. 1. Note that for purposes of illustration, at least some dimensions in the Z-direction are exaggerated for improved visibility of the represented aspects.

The illustrated embodiment of the waveguide 202 implements diffractive optical structures to control the light that enters, traverses, and exits the waveguide 202. For reference, opposite sides of the waveguide 202 are referred to as “an eye-facing side 205” and a “world-facing side 207.” Two regions 204, 210 of diffractive optical structures are provided on the eye-facing side 205 of the waveguide 202. The diffractive optical structures of the region 204 are configured to function as at least a portion of an incoupler for display light 206 received from a light source 209. The diffractive optical structures of region 210 are configured to function as at least a portion of an outcoupler for the display light 206 traveling through the waveguide 202. Diffractive optical structures of region 208 on the world-facing side 207 of the lens element 110 are configured to provide EPE functionality, as discussed herein.

The light source 209 generates the display light 206 representative of a plurality of pixels. The light source 209 includes components capable of performing angular pixel shifting in successive time intervals to produce an increased perceived display resolution. The diffractive optical structures in the region 204 (as well as other elements, if necessary) incouple the display light 206 to the waveguide 202. The display light 206 propagates (through total internal reflection in this example) through the waveguide 202 toward the region 208 and the diffractive optical structures of the region 208 diffract the incident display light for exit pupil expansion purposes. The diffracted light propagates to the diffractive optical structures of the region 210, which output the display light toward a user's eye 212. In some embodiments, the positions of regions 208 and 210 may be reversed, with the diffractive optical structures of region 210 formed on the world-facing side 207 and the diffractive optical structures of region 208 formed on the eye-facing side 205, however, this may result in the regions 208 and 210 having different positions, dimensions, and shapes, and also may require diffractive optical structures in each region to have different characteristics.

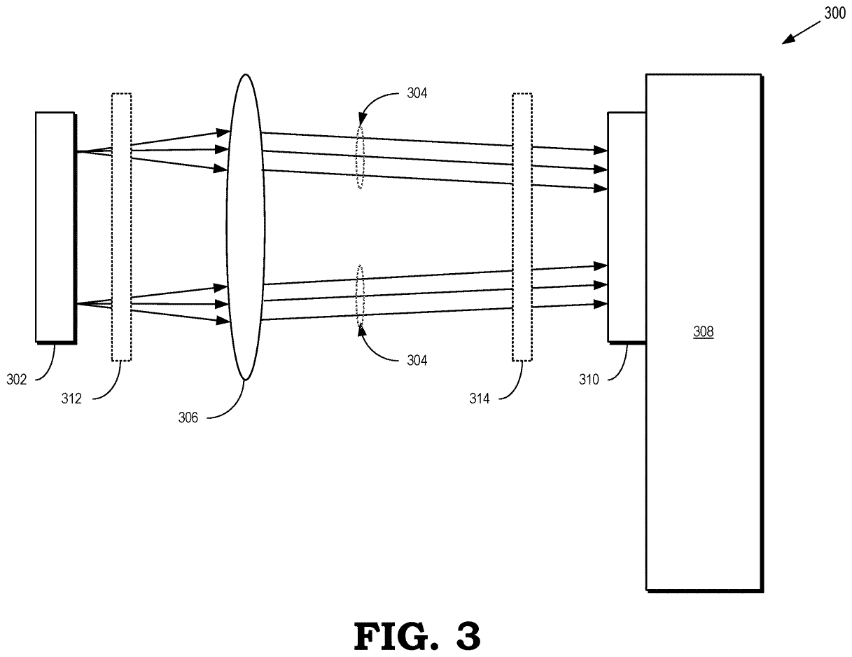

FIG. 3 illustrates an optical system 300 that supports time-multiplexing of virtual pixels that are produced by pixel shifting an image of a source pixel, according to some embodiments. The optical system 300 can be implemented in some embodiments of the AR eyewear display system 100 shown in FIG. 1 and the lens element shown in FIG. 2.

The optical system 300 includes a display 302 that can be implemented as an emissive micro-display such as a μLED display, μOLED display, micro-electromechanical system (MEMS) laser scanning projector, digital light processing (DLP) projector, or liquid crystal on silicon (LCoS) projector. The display 302 includes a set of pixels that are configured to generate light representing corresponding portions of images and project the generated light toward the eye of a user along a preconfigured optical path. As used herein, the term “pixel” refers to the physical pixel in the display 302 that generates light and the portion of the image represented by the light generated by the corresponding physical pixel. The light generated by the display 302 is represented as light rays or arrows 304 in FIG. 3. The arrows 304 indicate the optical path traversed by the light that represents one or more of the pixels, as well as a direction and angle of propagation of the light. Each pixel in the display 304 emits light in a cone having a predetermined opening angle that can be represented by a set of rays coming out of the pixel at different angles. However, in the interest of clarity, each of the pixels emitted by the display 304 shown in FIG. 3 is depicted as a single light ray propagating in a single direction.

A lens 306 represents optical elements in the optical system 300 that modify the light as it propagates from the display 302 to a waveguide 308. Modifications to the light can include, but are not limited to, collimation, concentration, or focusing of the light generated by the display 302 through refraction and/or diffraction. Projection optical systems can also include curved and flat mirrors, which modify light parameters by reflection. The lens 306 in the projection display transforms the positional distribution of pixels into an angular distribution. In other words, the lens 306 performs an optical Fourier transform. Some embodiments of the lens 306 include a projection lens, as well as additional lens elements deployed between the display 302 and the waveguide 308. The projection lens, additional lenses, or other optical elements in the lens 306 can be curved to improve the function of the projection lens while keeping the projection system size compact. The optical system also includes an incoupler 310 that couples the light generated by the display 302 (and modified by the lens 306) into the waveguide 308. As discussed herein, the incoupler 310 can include diffractive elements (or other optical elements) that modify an incoming angle of the light to an outgoing angle that facilitates propagation of the light through the waveguides 308, e.g., by total internal reflection at surfaces of the waveguide 308.

The optical system 300 supports pixel shifting by modifying an angle or direction or propagation of light representing pixels to generate multiple virtual pixels based on light generated by individual pixels in the display 302. The process of shifting a pixel location by modifying the angle or direction or propagation of the light representing the pixel is referred to herein as “angular pixel shifting.” The term “virtual pixel” refers to light that is produced by a physical pixel and projected to a location that is offset from a location of the light produced by the physical pixel in the absence of pixel shifting. For example, if the light produced by a physical pixel in the display 302 is projected to a first location, one or more virtual pixels are generated by modifying the optical path of the light produced by the physical pixel to project the light produced by the physical pixel to a second location that is offset from the first location. The offset can be represented as a pixel shifting distance that is equal to

$$n ( \frac{p}{2} ) ,$$

where n is an integer and p is the pitch of pixels within the display 302. Pixel shifting can be used to increase the pixel density and resolution of an image perceived by a user viewing an image through the optical system 300. Thus, pixel shifting helps maintain a high image quality while expanding a field of view of the optical system 300. In addition, pixel shifting can be used to avoid or eliminate visual artifacts such as the screen door effect. The pixel density and therefore the display resolution can be increased globally and/or locally. The latter can be used to implement foveated rendering, where one part of the virtual image is rendered at a higher resolution than the rest. Pixel shifting can also mitigate other issues associated with display panels. For example, pixel shifting can reduce or eliminate the “mura effect” that refers to a sense of cloudiness that is produced in the image perceived by a user due to unevenness, irregularity, or blemishes in the display panels. The mura effect can be caused by variations in the intensity or color of light generated by different pixels despite receiving the same electrical signal that represents the intensity or color of light that should be generated by the different pixels. For another example, pixel shifting can conceal the presence of the dead pixels, which are non-working or inoperative pixels that appear as dark or bright spots in the image displayed to the user. Moreover, pixel shifting can mitigate some image defects caused by the limitations of an optical system, for example image tiling due to limited number of replications in diffractive and refractive waveguides.

The optical system 300 illustrates two possible approaches to pixel shifting that can be implemented: positional pixel shifting and angular pixel shifting. A positional pixel shifter 312 is typically deployed in the space between the display 302 and the lens 306. The positional pixel shifter 312 is configured to shift a “position” of the light rays entering the positional pixel shifter 312 by a predetermined linear offset without changing the propagation angle of the light ray. For example, the positional pixel shifter 312 can shift an incoming light ray by a pixel offset distance of

$$δ d = n ( \frac{p}{2} ) ,$$

where n is an integer and p is the pitch of pixels within the display, as the light ray traverses the positional pixel shifter 312. The pixel shifter 314 is configured to shift or modify a first, incoming angle of the light ray to a different, outgoing angle that corresponds to different pixel position which can be determined by plotting the path of the deflected beam back to the panel. The pixel shifter 314 is typically deployed between the lens 306 and the waveguide 308. In some embodiments, which are discussed herein, additional optical elements can be deployed between the pixel shifter 314 and the waveguide 308.

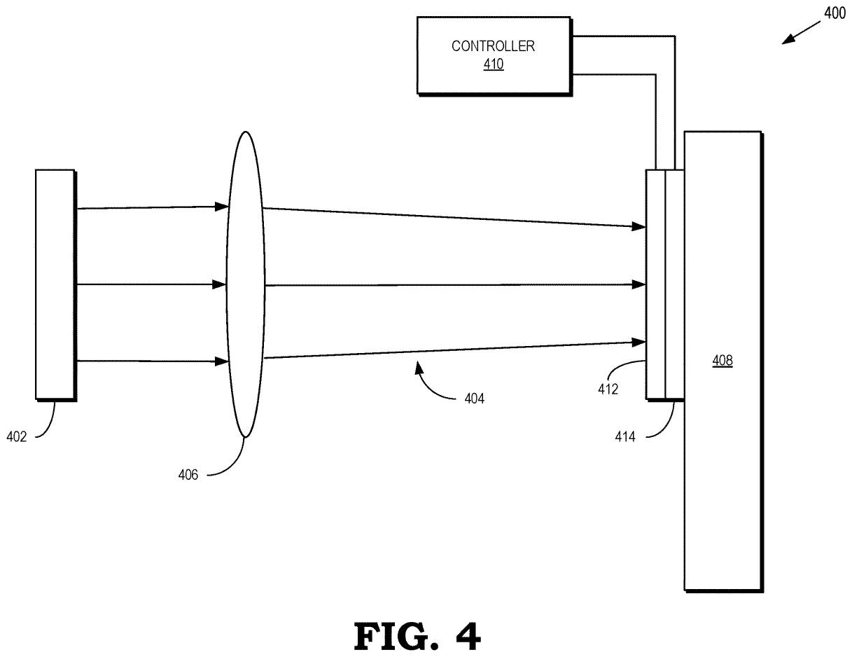

FIG. 4 illustrates an optical system 400 that includes an electro-optical pixel shifter for performing angular pixel shifting of a source pixel to produce one or more virtual pixels, according to some embodiments. The optical system 400 can be implemented in some embodiments of the AR eyewear display system 100 shown in FIG. 1 and the lens element shown in FIG. 2.

The optical system 400 includes a display 402 that includes a set of pixels that are configured to generate light representing corresponding portions of images (pixels) and project the generated light toward the eye of a user along a preconfigured optical path. The light generated by the display 402 is represented as light rays or arrows 404 that indicate the optical path traversed by the light that represents one or more of the pixels, as well as a direction and angle of propagation of the light. A lens 406 represents optical elements in the optical system 400 that modify the light as it propagates from the display 402 to a waveguide 408.

In the illustrated embodiment, the electro-optic pixel shifter includes a controller 410, a first incoupler 412, and a second incoupler 414. The first and second incouplers 412, 414, produce different deflection angles for the light propagating through the first and second incouplers 412, 414. In some embodiments, the first and second incouplers 412, 414 are configured as switchable incouplers that include diffraction gratings. One example of these gratings is a polarization volume grating (PVG) such as a polarization sensitive Bragg grating. The grating is polarization sensitive so that the light of one circular polarization diffracts while the light of the orthogonal circular polarization is unaffected. When this grating is active, for example, the grating made of active liquid crystal, the periodic grating structure can be eliminated by aligning the LC in an electric field. This causes a switch from the diffractive state to the non-diffractive state. Another example is a compound surface relief grating (SRG), e.g., an SRG filled with liquid crystal having one of its principal refractive indices (n° or ne) matching refractive index of the grating. This grating is operative on, or sensitive to, linear polarization; for the polarization that corresponds to the maximum difference between the refractive indices of the LC and the grating, the diffraction efficiency is maximized, while for orthogonal polarization, when the refractive indices are matched, there is no diffraction effect.

The gratings of the first incoupler 412 and the second incoupler 414 provide slightly different diffraction angles α₁ and α₂, which are incoupling angles in waveguide 408. The angular difference Δα=α₂−α₁ provides the expected pixel offset δd. If incoming light is unpolarized, each of the first and second incouplers 412, 414 includes two gratings operative on, or sensitive to, mutually orthogonal polarizations. If the incoming light is polarized, a single grating corresponding to the polarization of the incoming light is used to implement each of the first and second incouplers 412, 414.

The electro-optic pixel shifter generates virtual pixels at different pixel shifting distances by modifying incoming angles of the light rays 404 to one of a set of outgoing angles that correspond to angles of the light as it enters the waveguide 408. The controller 410 is implemented with circuitry that provides signaling to the first and second incouplers 412, 414. The control signaling indicates one of a plurality of angles or directions of propagation of outgoing light from the first and second incouplers 412, 414. For polarized light, the first and second incouplers 412, 414 can be driven directly in response to signals provided by the controller 410 or by an external polarization rotator (not shown in FIG. 4) which outputs one of two orthogonal polarizations in response to signals provided by controller 410. For non-polarized light, the first and second incouplers 412, 414 are driven directly by the signals provided by the controller 410.

In operation, frames that represent images produced by the display 402 are subdivided into a plurality of subframes. In some embodiments, the frames are subdivided into two subframes and the time interval of each subframe corresponds to half the time interval of the frame. The signals generated by the controller 410 are coordinated with the timing of the frames produced by the display 402 so that the controller 410 activates or deactivates the first and second incouplers 412, 414 to produce different angular pixel shifts in different subframes. The coordinated operation of the display 402 and the controller 410 can be used for different purposes including doubling the resolution of the image produced by the display 402 and/or mitigating defects in the display 402. To increase the resolution, the content of one subframe corresponds to an unshifted matrix of pixels (which may be referred to herein as the real or actual pixels) and the content of the other subframe corresponds to a shifted matrix of pixels (which may be referred to herein as the virtual pixels). The angular pixel shift is configured so that the virtual pixels fill in gaps between the real pixels. To mitigate display defects, the content of the second subframe is preferably shifted (relative to the first subframe) by one or more periods that are equal to the direction and/or number of periods provided by a beam shifter. The viewer therefore perceives the same image in the two subframes, as discussed herein.

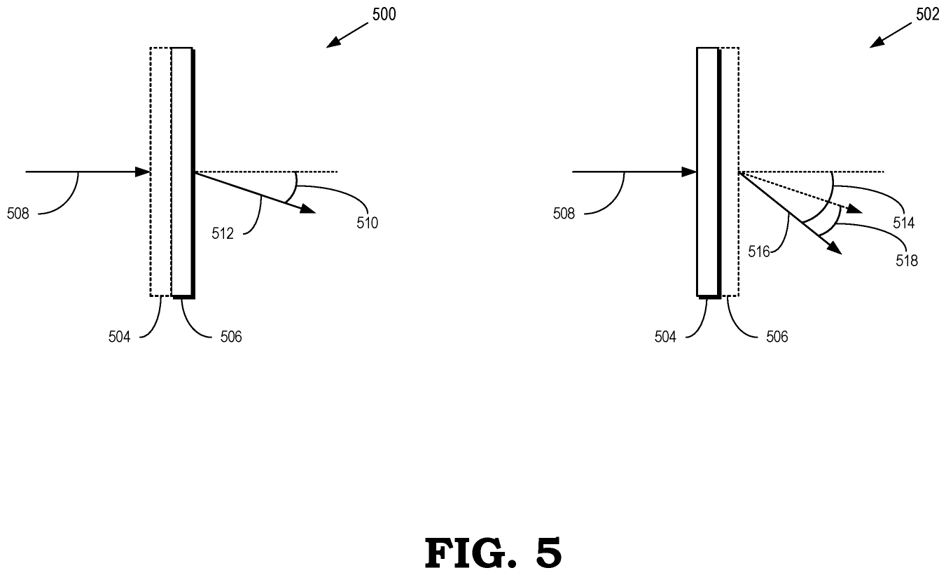

FIG. 5 illustrates a portion of an electro-optic pixel shifter in a first state 500 and a second state 502, according to some embodiments. The electro-optic pixel shifter includes a first incoupler 504 that represents some embodiments of the first incoupler 412 shown in FIG. 4 and a second incoupler 506 that represents some embodiments of the second incoupler 414 shown in FIG. 4. The electro-optic filter includes a controller that corresponds to the controller 410 shown in FIG. 4, but which is not shown in FIG. 5 in the interest of clarity.

In the first state 500, signals provided to the first incoupler 504 and the second incoupler 506 by the controller deactivate, or turn off, the first incoupler 504 and activate, or turn on, the second incoupler 506. The deactivated first incoupler 504 does not modify the propagation angle of incoming light 508. The activated second incoupler 506 modifies the propagation angle of the incoming light 508. In the illustrated embodiment, the activated second incoupler 506 deflects, by refraction, diffraction or/and reflection, the incoming light 508 by an angle 510 (also represented as the symbol α₁) to form the outgoing light 512.

In the second state 502, signals provided to the first incoupler 504 and the second incoupler 506 by the controller activate, or turn on, the first incoupler 504 and deactivate, or turn off, the second incoupler 506. The activated first incoupler 504 modifies the propagation angle of incoming light 508. The deactivated second incoupler 506 does not modify the propagation angle of the incoming light 508. In the illustrated embodiment, the activated first incoupler 504 deflects the incoming light 508 by an angle 514 (also represented as the symbol α₂) to form the outgoing light 516.

Angular pixel shifting between the first state 500 and the second state 502 corresponds to the difference between the angle 512 and the angle 514 so that the angular shift 518 of the pixels is Δα=α₂−α₁. The first incoupler 504 and the second incoupler 506 are configured to produce an angular shift 518 corresponding to a pixel shifting distance that is equal to

$$n ( \frac{p}{2} ) ,$$

where n is an integer and p is the pixel pitch. The integer n is typically set to an odd value to increase pixel density and an even value to mitigate display defects.

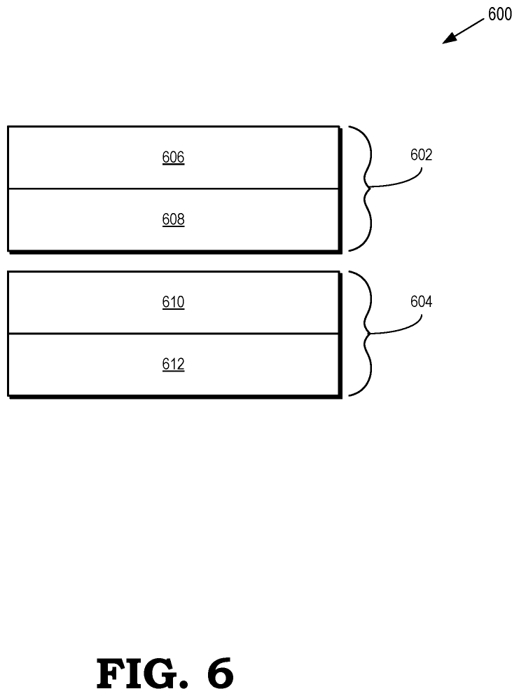

FIG. 6 illustrates a polarization stack 600 that includes two incouplers 602, 604 that are operative on, or sensitive to, two orthogonal polarizations of the same type, according to some embodiments. The incouplers 602, 604 in polarization stack 600 are used to implement some embodiments of the incouplers 412, 414 shown in FIG. 4 and the incouplers 504, 506 shown in FIG. 6. In the illustrated embodiment, the incoupler 602 includes gratings 606, 608 that are operative on, or sensitive to, orthogonal polarizations and the incoupler 604 includes gratings 610, 612 that are operative on, or sensitive to, orthogonal polarizations. The type of the orthogonal polarizations can be linear or circular.

The polarization stack 600 forms the active elements in a pixel shifter (such as the pixel shifter shown in FIG. 4) that modifies the angles of incoming unpolarized light that represents pixels produced by a display such as the display 402 shown in FIG. 4. If the light produced by the display is polarized, only one of the gratings 606, 608, 610, 612 in each of the incouplers 602, 604 is sufficient to perform angular pixel shifting. In the illustrated embodiment, the gratings 606, 608, 610, 612 are active so that they are configured to be switched (e.g., activated or deactivated) in response to an electrical signal provided by a controller such as the controller 410 shown in FIG. 4. For example, when a control signal activates the incoupler 602, both the gratings 606, 608 are activated and when the control signal deactivates the incoupler 602, both the gratings 606, 608 are deactivated. For another example, when a control signal activates the incoupler 604, both the gratings 610, 612 are activated and when the control signal deactivates the incoupler 604, both the gratings 610, 612 are deactivated.

The gratings 606, 608, 610, 612 are configured to provide a relatively high angle of diffraction to support incoupling projector light to a waveguide and a relatively high diffraction efficiency for the ±1 diffraction order. In some embodiments, the gratings 606, 608, 610, 612 are implemented as active PVG gratings. The PVG gratings 606, 610 are configured to be operative on, or sensitive to, a first circular polarization state and the PVG gratings 608, 612 are configured to be operative on, or sensitive to, a second circular polarization state that is orthogonal to the first circular polarization state. In some embodiments, the gratings 606, 608, 610, 612 are implemented as active compound SRG gratings. The SRG gratings 606, 610 are configured to be operative on, or sensitive to, a first linear polarization state and the SRG gratings 608, 612 are configured to be operative on, or sensitive to, a second linear polarization state that is orthogonal to the first linear polarization state.

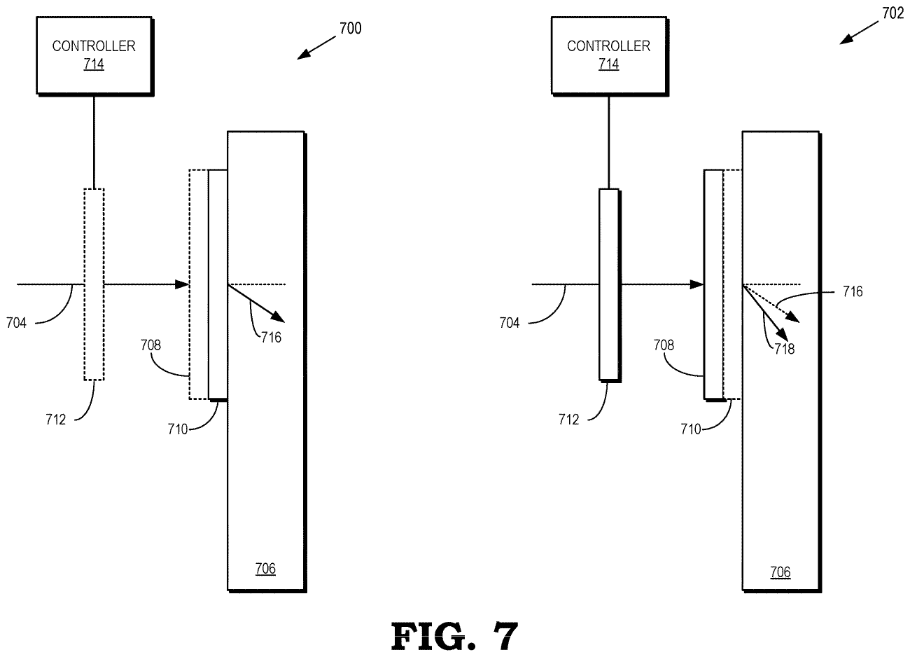

FIG. 7 illustrates an optical system including an electro-optical pixel shifter in a first and second states 700, 702 that represent switching based on a polarization state of incoming light 704, according to some embodiments. The optical system 700 can be implemented in some embodiments of the AR eyewear display system 100 shown in FIG. 1 and the lens element shown in FIG. 2. The lens element can also be a reflective waveguide having built-in mirrors and prisms instead of gratings, as in the diffractive waveguide in FIG. 2. The optical system 700 can also be implemented in systems that generate or transmit polarized light, e.g. for LCoS display or a laser based projector. For emissive displays (e.g., a μLED or μOLED display) emitting unpolarized light the optical system shown in FIG. 7 can be used if a polarizer is deployed after the display panel. The polarizer can be linear or circular depending on gratings used as incouplers.

The electro-optical pixel shifter modifies an angle of the incoming light 704 and provides the lights to a waveguide 706 at one of a plurality of angles. The electro-optical pixel shifter includes an incoupling element formed of first and second incouplers 708, 710 that are operative on, or sensitive to, different, orthogonal polarizations. For example, the first incoupler 708 can be a PVG grating that is operative on, or sensitive to, a first circular polarization and the second incoupler 710 can be a PVG grating that is operative on, or sensitive to, a second circular polarization orthogonal to the first circular polarization. For another example, the first incoupler 708 can be an SRG grating that is operative on, or sensitive to, a first linear polarization and the second incoupler 710 can be an SRG grating that is operative on, or sensitive to, a second linear polarization orthogonal to the first linear polarization. The electro-optical pixel shifter also includes a polarization switch 712 that switches the polarization of the incoming light 704 between the orthogonal polarization states. The polarization switch 712 can be implemented using twisted nematic liquid crystal cells, switchable half-wave liquid crystal plates, and the like. The liquid crystal based polarization switch can be pixelated when only a selected set of pixels (i.e., selected area of image) can be shifted.

In the first state 700, circuitry used to implement a controller 714 provides a signal that deactivates (or turns off) the polarization switch 712 so that the polarization switch 712 is substantially transparent to the first polarization state. The incoming light 704 (or a portion thereof) having the first polarization state propagates through the polarization switch 712. The first incoupler 708 does not modify the propagation angle of the incoming light 704 and the second incoupler 708 modifies the propagation angle of the incoming light 704 to form outgoing light 716 having a first, modified propagation angle.

In the second state 702, the controller 714 provides a signal that activates (or turns on) the polarization switch 712 so that the polarization switch 712 is substantially transparent to the second polarization state. The incoming light 704 (or a portion thereof) having the second polarization state propagates through the polarization switch 712. The first incoupler 708 modifies the propagation angle of the incoming light 704 to a second, modified propagation angle and the second incoupler 708 does not modify the propagation angle of the incoming light 704, thereby forming outgoing light 718. Thus, as discussed herein, the electro-optical pixel shifter shown in FIG. 7 is configured to shift pixels by an angle equal to a difference between the first and second propagation angles.

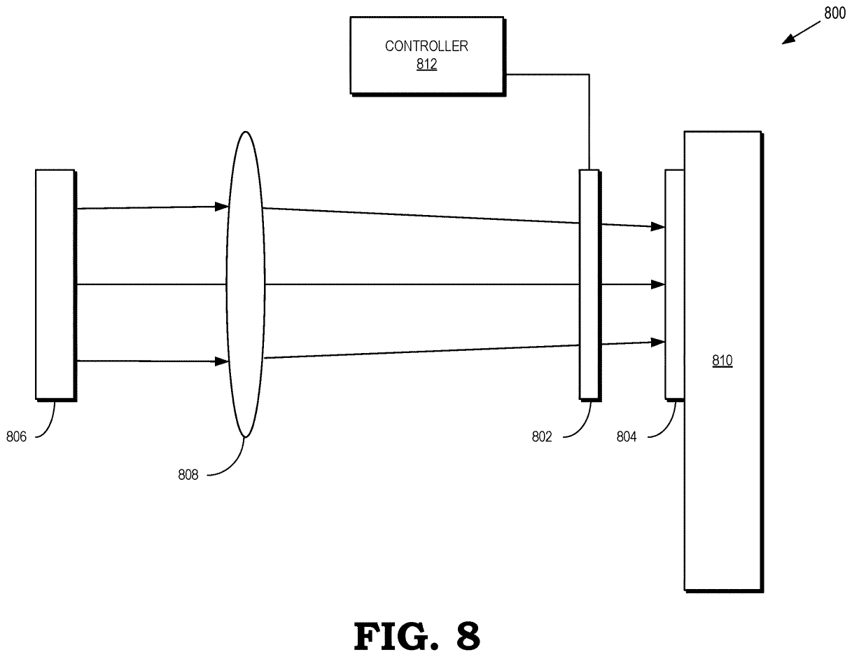

FIG. 8 illustrates an optical system 800 that includes an electro-optical pixel shifter having an active angular shifter 802 and a static incoupler 804, according to some embodiments. The optical system 800 can be implemented in some embodiments of the AR eyewear display system 100 shown in FIG. 1 and the lens element shown in FIG. 2.

The optical system 800 includes a display 806 that includes a set of pixels that are configured to generate light representing corresponding portions of images (pixels) and project the generated light toward the eye of a user along a preconfigured optical path. The light generated by the display 806 is represented as light rays that indicate the optical path traversed by the light that represents one or more of the pixels, as well as a direction and angle of propagation of the light. A lens 808 represents optical elements in the optical system 800 that modify the light as it propagates from the display 806 to a waveguide 810.

In the illustrated embodiment, the electro-optic pixel shifter includes a controller 812, an electro-optical angular shifter 802, and a static incoupler 804. Switchable angular shifter 802 in the ON state provides a small angle increment corresponding to the expected pixel shift. As discussed herein, the switchable shifter 802 can be implemented as a single switchable grating for polarized incoming light and as two switchable gratings (operative on, or sensitive to, orthogonal polarizations) for unpolarized incoming light. When activated or switched on in response to signals provided by circuitry used to implement the controller 812, the switchable shifter 802 produces an angular shift of a first angle α₁ and when deactivated or switched off in response to signals provided by the controller 812, the shifter 802 does not produce an angular shift. The static incoupler 804 produces an incoupling angle α₂ independent of the signals provided by the controller 812. Thus, the electro-optical angular shifter 802 provides increment of incoupling angle α₂ of image light to the waveguide 810 corresponding to desirable pixel shift.

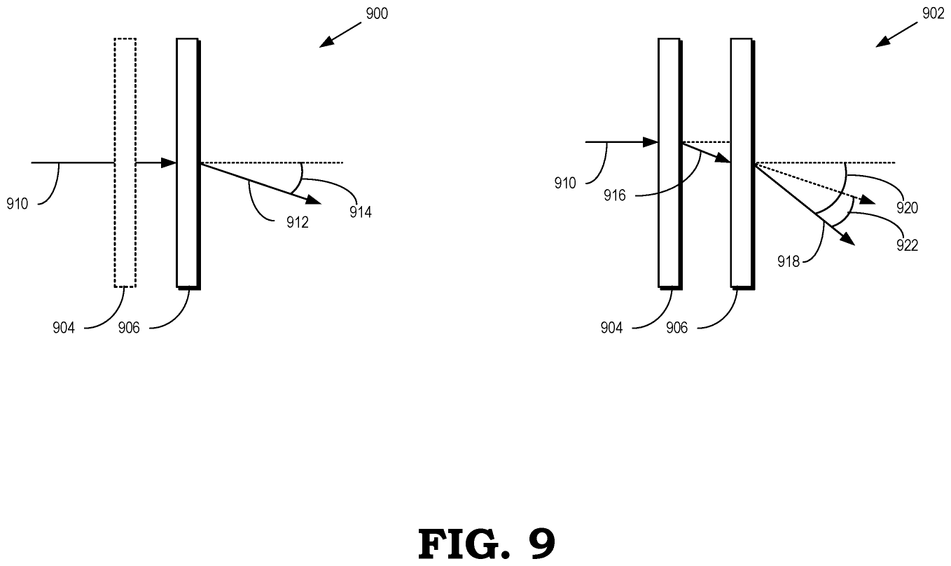

FIG. 9 illustrates angular pixel shifting of polarized light in one direction by an active switchable angular shifter 904 in a first state 900 and a second state 902, according to some embodiments. The arrangement shown in FIG. 9 includes an active switchable angular shifter 904 and a static incoupler 906 that can be used to implement some embodiments of the shifter 802 and the incoupler 804, respectively, shown in FIG. 8.

The angular switchable shifter 904 outputs one of two orthogonal polarization states depending on a control signal provided by a controller such as the controller 812 shown in FIG. 8. Some embodiments of the angular switchable shifter 904 are implemented as a single active liquid crystal prism, i.e., wedge liquid crystal cell, or a compound prism array or Fresnel prism that is made up of two adjacent prism arrays made of active liquid crystal and polymer, respectively. The refractive index of LC prisms can be switched between ordinary, n^{o}, and extraordinary one, n^{e}, due to LC reorientation in the applied electric field. This may result in switching the light deflection angle of the prisms from 0 or α₁₁≠0 and α₁₂.

In the first state 900, the active shifter 904 is deactivated and provides shifting angle α₁₁ for the incoming light 910, which can be assumed to have a propagation angle of zero. The static incoupler 906 modifies an angle of the incoming light 910 to change the propagation direction of the outgoing light 912 by an angle 914.

In the second state 902, the active shifter 904 is activated and therefore modifies an angle of first, incoming light 910 to change a propagation direction of second, modified light 916 by a first angle, α₁₂>α₁₁. The static incoupler 906 further modifies an angle of the second, modified light 916 to change the propagation direction of the third, outgoing light 918 by the angle 914. Thus, the propagation angle of the third, outgoing light 918 is modified by a total angle 920 so that the active pixel shifter is configured to create angular pixel shifts of an angle 922 equal to a difference between the angles 914 and 920.

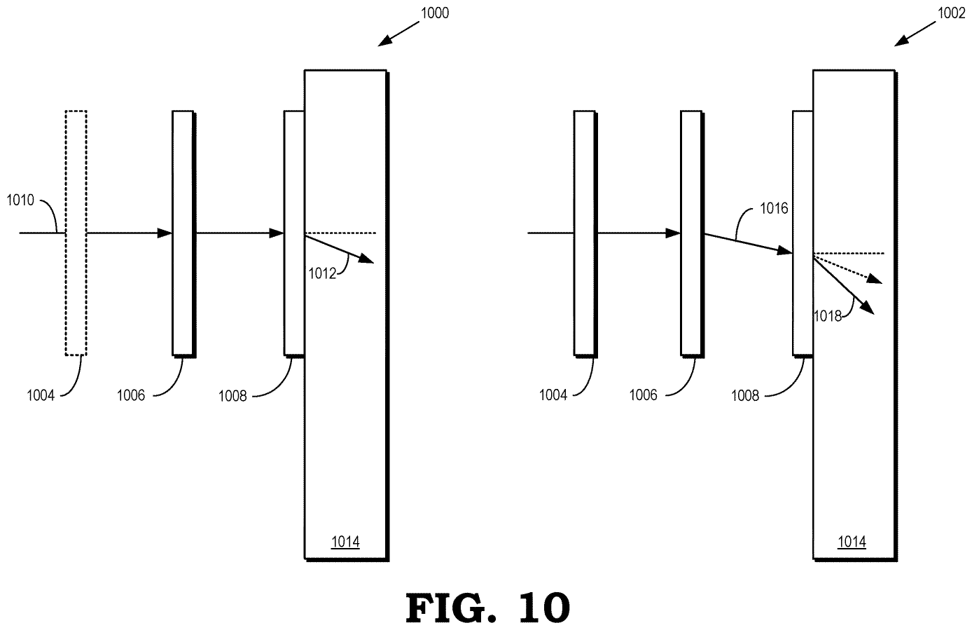

FIG. 10 illustrates angular pixel shifting of polarized light in one direction by a passive switchable angular shifter in a first state 1000 and a second state 1002, according to some embodiments. The passive switchable angular shifter shown in FIG. 10 includes a polarization switch 1004 and a polarization dependent passive angular shifter 1006 that can be used to implement some embodiments of the first angular beam shifter 802 shown in FIG. 8. The arrangement shown in FIG. 10 also includes a static incoupler 1008 that can be used to implement some embodiments of the incoupler 804 shown in FIG. 8.

The polarization switch 1004 outputs one of two orthogonal polarization states depending on a control signal provided by a controller such as the controller 812 shown in FIG. 8. The polarization dependent passive shifter 1006 has a first, extraordinary index of refraction for light in a first polarization state and a second, ordinary index of refraction for light in a second polarization state that is orthogonal to the first polarization state. Thus, switching the polarization switch 1004 between states that outputs light having the first or second polarization states causes the polarization dependent incoupler 1006 to modify the propagation angle of incoming light by different amounts in the different states. The examples of passive angular shifters 1006 are a single active liquid crystal prism, prism array or Fresnel prism made of active or passive LC. Another example can be a compound prism array of liquid crystal and polymer. These prisms are operative on, or sensitive to, linear polarization when the LC has uniform planar alignment. For polarizations of light corresponding to n^{o} and n^{e} indices of refraction, deflection angle of light caused by the prisms will be different, α₁₁≠α₁₂. FIG. 10 illustrates the proposed approach for α₁₁=0.

In the first state 1000, the polarization switch 1004 is deactivated or turned off in response to a control signal. The polarization state of the incoming light 1010 is modified to the first polarization state and consequently the propagation angle of incoming light 1010 is not modified by the polarization dependent incoupler 1006. The static incoupler 1008 modifies the propagation direction of the outgoing light 1012 that is provided to the waveguide 1014 by a first angle.

In the second state 1002, the polarization switch 1004 is activated or turned on in response to the control signal. The polarization state of the incoming light 1010 is modified to the second polarization state and consequently the propagation direction of the incoming light 1010 is modified by a second angle to produce the outgoing light 1016. The static incoupler 1008 modifies the propagation direction of the outgoing light 1016 by the first angle so that the propagation direction of the light 1018 provided to the waveguide 1014 is modified, relative to the propagation direction of the outgoing light 1012 that is provided to the waveguide 1014 in the first state. The angle between the beams 1012 and 1018 is an angular shift that provides the expected pixel offset. In some embodiments, the desired pixel shift can be obtained for a selected set or subset of pixels (i.e., selected part of image), for example by using pixelated polarization switch that activates only part of angular shifter.

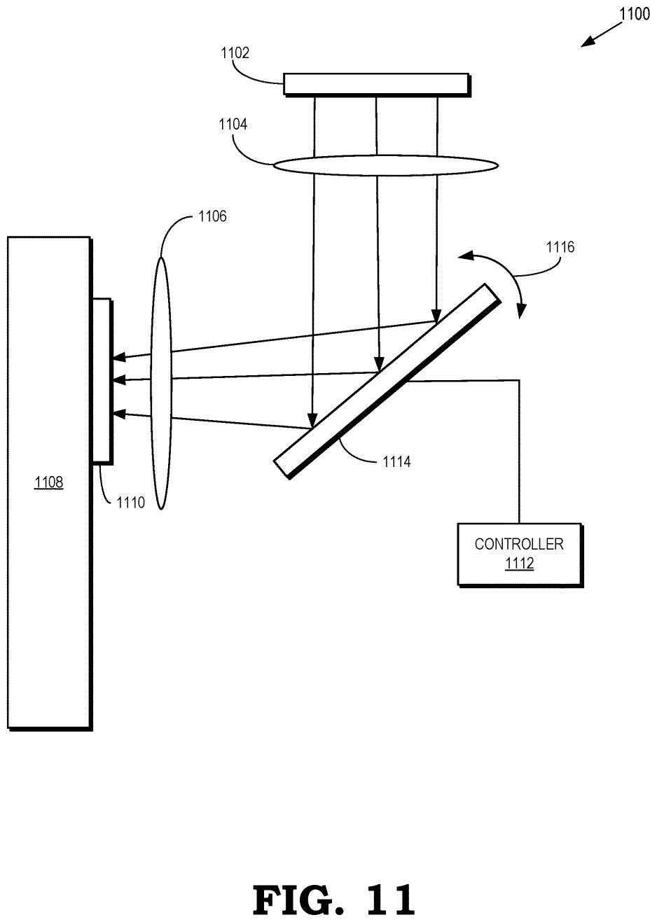

FIG. 11 illustrates an optical system 1100 that includes an electro-mechanical pixel shifter for performing angular pixel shifting of a source pixel to produce one or more virtual pixels, according to some embodiments. The optical system 1100 can be implemented in some embodiments of the AR eyewear display system 100 shown in FIG. 1 and the lens element shown in FIG. 2.

The optical system 1100 includes a display 1102 that includes a set of pixels that are configured to generate light representing corresponding portions of images (pixels) and project the generated light toward the eye of a user along a preconfigured optical path. The light generated by the display 1102 is represented as light rays that indicate the optical path traversed by the light that represents one or more of the pixels, as well as a direction and angle of propagation of the light. In the illustrated embodiment, the electromechanical pixel shifter is deployed between portions of the optical elements that make up the optical system 1100. A first lens 1104 and a second lens 1106 represent optical elements in the optical system 1100 that modify the light as it propagates from the display 1102 to a waveguide 1108. An incoupler 1110 couples light received from the second lens 1106 into the waveguide 1108 at an angle that allows the like to propagate through the waveguide 1108, e.g., according to one or total internal reflections.

In the illustrated embodiment, the electro-mechanical pixel shifter includes a controller 1112 and an electrically controllable wobbling reflector 1114. The reflector 1114 can be implemented as an electromechanical wobbling mirror such as a metallic mirror with piezo actuators, a digital micromirror device (DMD), microelectromechanical systems (MEMS), and the like. An orientation of the controllable reflector 1114 is rotated in response to signals received from the controller 1112, as indicated by the double-headed arrow 1116. In some embodiments, a mirror rotation of 0.1° provides a substantially uniform image shift or pixel shift of approximately 10 μm without noticeable aberration.

The electro-mechanical pixel shifter generates virtual pixels at different pixel shifting distances by modifying incoming angles of the light to one of a set of outgoing angles that correspond to angles of the light as it enters the waveguide 1108. The display 1102 and the controller 1112 are coordinated so that the display 1102 generates pixels in subframes of an image frame and the controller 1112 provides signals to rotate the tunable mirror 1114 to different angles in the subframes. Values of the pixels generated by the display 1102 in the different subframes can be the same (e.g., to mitigate defects in the display 1102) or different (e.g., to increase the perceived resolution of the display 1102).

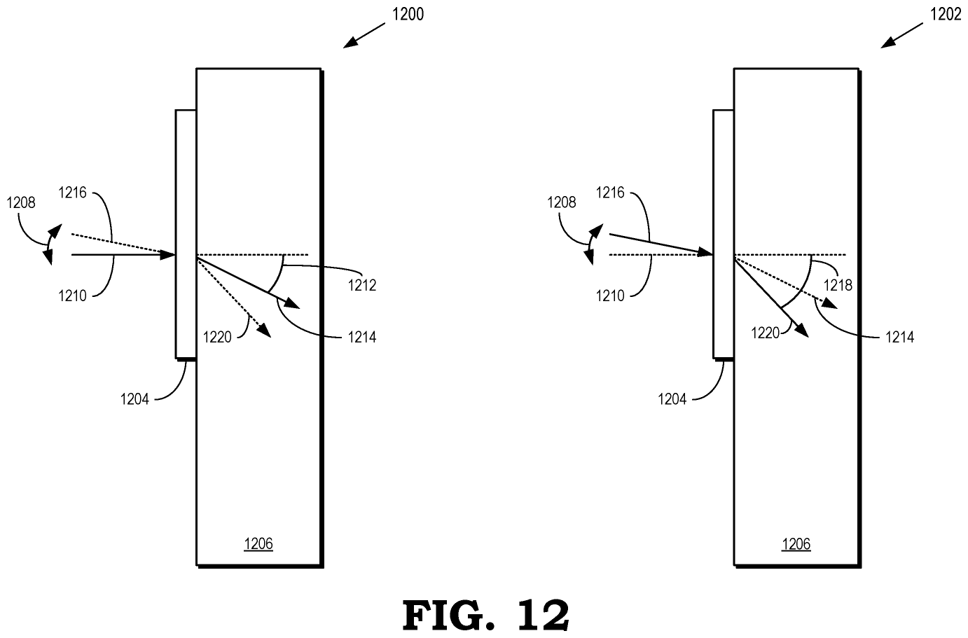

FIG. 12 illustrates angular pixel shifting by an electromechanical pixel shifter in a first state 1200 and a second state 1202, according to some embodiments. The electromechanical pixel shifter receives light from a controllable reflector such as the reflector 1114 shown in FIG. 11. The system shown in FIG. 11 also includes an incoupler 1204 that can be used to implement some embodiments of the incoupler 1110 shown in FIG. 11. The incoupler 1204 is connected to, or adjacent to, a waveguide 1206. As discussed herein, the wobbling controllable reflector can modify propagation direction of light that is incident on the incoupler 1204 through a range 1208 of angles.

In the first state 1200, light 1210 is incident on the incoupler 1204 along a first direction determined by the controllable reflector. The incoupler 1204 modifies the propagation direction of the light by a first angle 1212 and then the modified light 1214 enters the waveguide 1206 along the modified propagation direction.

In the second state 1202, light 1216 is incident on the incoupler 1204 along a second direction determined by the tunable reflector, which is rotated relative to the orientation of the controllable reflector in the first state 1200. The incoupler 1204 further modifies the propagation direction of the light by a second angle 1218 and then the modified light 1220 enters the waveguide 1206 along the modified propagation direction. The system is therefore configured to shift pixels through an angle corresponding to a difference between the angle 1218 and the angle 1212.

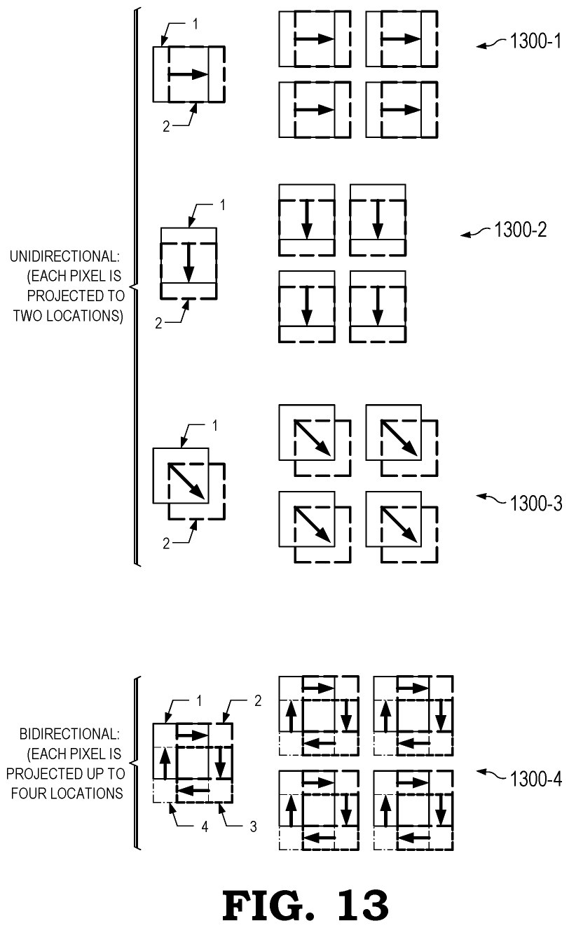

FIG. 13 is a set of diagrams 1300 illustrating unidirectional and bidirectional pixel shifting produced by angular pixel shifting, according to some embodiments. The pixel shifts illustrated in FIG. 13 are produced by some embodiments of the pixel shifters illustrated in FIGS. 3-12.

Diagrams 1300-1, 1300-2, and 1300-3 illustrate how pixels can be shifted using a unidirectional pixel shifter such as embodiments of the pixel shifters discussed herein. An individual pixel can be shifted horizontally, vertically, or diagonally to produce two virtual pixels for each native pixel of the light engine. As shown in diagram 1300-4, a bidirectional pixel shifter formed using combinations of angular pixel shifting elements can shift individual pixels horizontally and vertically to produce four or more virtual pixels (depending on the number and orientation of the angular pixel shifting elements) for each real or actual pixel of the display that generates the real or actual pixels. Although diagram 1300-4 illustrates horizontal and vertical shifting, diagonal shifting may also be implemented depending on the orientation of the angular pixel shifting elements.

Although FIGS. 1-13 illustrate pixel shifters deployed in the context of an AR or MR display system such as an AR eyewear display system, some embodiments of the pixel shifters disclosed herein are implemented in other contexts. For example, projectors such as LEA projectors can incorporate a pixel shifter at or near the plane of a folding mirror that is ploy between two sets of lenses within a lens barrel of the projector. For another example, a pixel shifter can be incorporated within a VR display system.

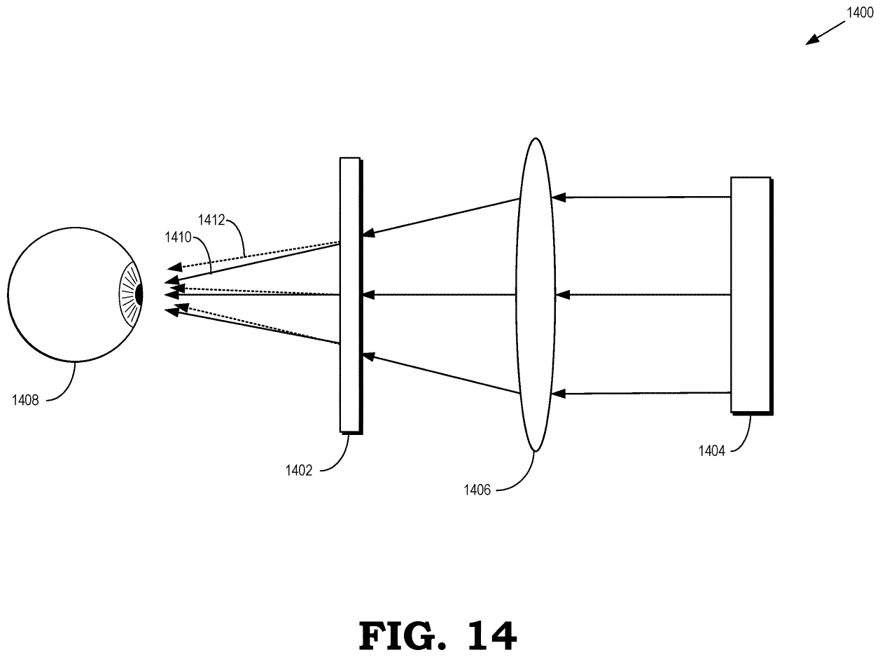

FIG. 14 illustrates a VR display system 1400 that includes a pixel shifter 1402, according to some embodiments. The pixel shifter 1402 can be implemented using some embodiments of the pixel shifters illustrated in FIGS. 1-13. The VR display system 1400 also includes a display 1404 that includes a set of pixels configured to generate light representing images that vary in successive frames or subframes. A lens 1406 modifies a propagation direction of the light as it propagates from the display 1404 towards an eye 1408 of a user.

The pixel shifter 1402 is configured to modify the direction of incoming light received from the lens 1406. As discussed herein, the direction of the incoming light is modified to shift an angle of the light by a predetermined amount corresponding to a pixel shifting distance. In the illustrated embodiment, the pixel shifter 1402 can modify the propagation direction of the incoming light from a first direction (indicated by the arrow 1410) to a second direction (indicated by the arrow 1412).

Note that not all the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above regarding specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the embodiments disclosed above may be altered or modified and all such variations are considered within the scope of the disclosed subject matter. Accordingly, the protection sought herein is set forth in the claims below.

What is claimed is:

1. An apparatus comprising:
a pixel shifter configured to receive light representative of a plurality of pixels and to modify a first angle of the light to one of a plurality of predetermined second angles based on a control signal; and
a controller configured to provide the control signal to the pixel shifter, wherein the control signal indicates different ones of the plurality of predetermined second angles in different time intervals corresponding to subframes of an image frame produced by the plurality of pixels.

2. The apparatus of claim 1, further comprising:
a waveguide configured to receive the light from the pixel shifter at the one of the plurality of predetermined second angles and to convey the light to an incoupler that renders the light visible to a user.

3. The apparatus of claim 1, wherein the pixel shifter is configured to modify the first angle of the light by at least one of diffracting, refracting, or reflecting the light to the one of the plurality of predetermined second angles.

4. The apparatus of claim 1, wherein the pixel shifter comprises:
first and second incouplers that have first and second indices of refraction, respectively, to produce different refraction or diffraction angles in light propagating through the first and second incouplers, and wherein a difference between the different refraction or diffraction angles represents an angular shift providing a predetermined pixel offset.

5. The apparatus of claim 4, wherein the first and second incouplers comprise at least one of a polarization volume grating, a liquid crystal compound surface relief grating, or a liquid crystal prism or prism array.

6. The apparatus of claim 4, wherein the first and second incouplers comprise at least two gratings operative on orthogonal polarizations.

7. The apparatus of claim 6, further comprising:
a polarization switch configured to switch between a first polarization state and a second polarization state in response to the control signal received from the controller.

8. The apparatus of claim 1, wherein the pixel shifter comprises:
an active angular shifter configured to produce an angular shift of a third angle in response to being activated by the control signal received from the controller and produce an angular shift of a fourth angle, different than the third angle, in response to being deactivated by the control signals provided by the controller; and
a static incoupler configured to produce an angular shift of a fifth angle independent of the control signal provided by the controller.

9. The apparatus of claim 8, wherein the active angular shifter comprises a liquid crystal prism or a liquid crystal prism array.

10. The apparatus of claim 1, wherein the pixel shifter comprises at least one mirror that rotates in response to the control signal provided by the controller, and wherein rotation of the mirror modifies the first angle of the light to the one of the plurality of second angles.

11. A method comprising:
receiving light representative of a plurality of pixels at a pixel shifter;
modifying, at the pixel shifter, a first angle of the light to one of a plurality of predetermined second angles based on a control signal indicating different ones of the plurality of predetermined second angles in different time intervals corresponding to subframes of an image frame produced by the plurality of pixels; and
incoupling the modified light propagating at the one of the plurality of predetermined second angles to a waveguide.

12. The method of claim 11, wherein modifying the first angle of the light comprises at least one of diffracting, refracting, or reflecting the light to the one of the plurality of predetermined second angles.

13. The method of claim 12, wherein modifying the first angle of the light comprises modifying the first angle using first and second incouplers that comprise at least two gratings sensitive to orthogonal polarizations, and wherein modifying the first angle of the light comprises modifying the first angle based on a polarization state of the light.

14. The method of claim 12, wherein modifying the first angle of the light comprises:
receiving the light at a controllable reflector; and
rotating the controllable reflector to modify the first angle of the light to the one of the plurality of predetermined second angles.

15. A display system comprising:
a display configured to generate light representative of pixels that represent frames of an image;
at least one lens element configured to modify the light representative of the pixels as the light propagates from the display to a user of the display system; and
a pixel shifter configured to receive the modified light and to modify a first angle of the modified light to one of a plurality of predetermined second angles that correspond to a pixel shifting distance.

16. The display system of claim 15, wherein the pixel shifter comprises:
first and second incouplers that have first and second indices of refraction, respectively, to produce different refraction, reflection, or diffraction angles in light propagating through the first and second incouplers, and wherein a difference between the different refraction, reflection, or diffraction angles represents an angular shift providing a predetermined pixel offset.

17. The display system of claim 15, wherein the pixel shifter comprises:
an active angular shifter configured to produce an angular shift of a first angle in response to being activated and to not produce an angular shift in response to being deactivated by the control signals provided by the controller; and
a static incoupler configured to produce an angular shift of a second angle independent of the control signal provided by the controller.

18. The display system of claim 15, wherein the pixel shifter comprises:
a mirror that rotates to modify the first angle of the light to the one of the plurality of predetermined second angles.

19. The display system of claim 15, wherein the pixel shifter is configured to modify the first angle of the light to increase a resolution of at least a portion of the image perceived by the user, mitigate or eliminate local defects in the display, or a combination thereof.

20. The display system of claim 15, wherein the display is configured to render graphical content in the frames, and wherein the at least one lens element is configured to superimpose the graphical content over or in conjunction with a real-world view as perceived by the user through the at least one lens element.
